(19) United States
(12) Patent Application Publication
(10) Pub. No.: US 2017/0065896 A1
(43) Pub. Date: Mar. 9, 2017

(54) LIVE ACTION, REAL TIME, FANTASY SPORTS

(71) Applicants: Russell Nevins, Las Vegas, NV (US); Chad Nevins, Las Vegas, NV (US)

(72) Inventors: Russell Nevins, Las Vegas, NV (US); Chad Nevins, Las Vegas, NV (US)

(21) Appl. No.: 15/209,673

(22) Filed: Jul. 13, 2016

Related U.S. Application Data
(60) Provisional application No. 62/327,374, filed on Apr. 25, 2016.
(60) Provisional application No. 62/318,714, filed on Apr. 5, 2016.

(51) Int. Cl. A63F 13/828; A63F 13/87; A63F 13/537; A63F 13/35

(52) U.S. Cl. CPC A63F 13/828; A63F 13/35; A63F 13/87; A63F 13/537

(57) ABSTRACT

Disclosed is a fantasy sports league having a plurality of competing fantasy sports teams, where each team is managed by at least one fantasy team shareholder and includes a plurality of players. The fantasy sports league also includes at least one fantasy team shareholder who selects each player to be on the respective fantasy sports team and each of the competing fantasy sports teams play a real-life sports game against at least one of the other competing fantasy sports teams.

### CROSS-REFERENCE TO RELATED APPLICATIONS

This application claims the benefit of Provisional U.S. Patent Application No. 62/318,714, filed on Apr. 5, 2016, and 62/327,374, filed on Apr. 25, 2016, which are hereby incorporated by reference herein in their entirety, including but not limited to those portions that specifically appear hereinafter, the incorporation by reference being made with the following exception: in the event that any portion of the above-referenced applications are inconsistent with this application, this application supersedes said above-referenced applications.

### STATEMENT REGARDING FEDERALLY SPONSORED RESEARCH OR DEVELOPMENT

Not Applicable.

### BACKGROUND

The disclosure relates generally to interactive fantasy sports games and leagues, and the methods and systems enabling and facilitating the participation, organization and administration of such games and leagues.

Conventional fantasy sports, fantasy football in particular, have many different embodiments, rules and formats. Most known embodiments of fantasy sports include forming a pool of participants. Each participant forms and manages a virtual sports team. These virtual teams are generally formed using current professional sports players, although there may be embodiments that use players of semi-profession or amateur league players, instead or as well. Fantasy sports may include football, baseball, hockey, soccer, or any other desired sport.

Conventional fantasy sports are generally played over a full sports season, however, fantasy sports may also typically be played over a single game or, alternatively, over multiple seasons. Before the start of a season, each of the fantasy sports team managers participates in a player draft, where players are selected for each team. During the draft each manager selects multiple players at specific player positions, fielding a full fantasy sports team. After the draft is completed, each manager will have a fully staffed fantasy sports team. However, each of the players on the fantasy sports team remain on their actual, real life, professional/semi-professional/amateur team and are only virtually represented on the corresponding fantasy sports team, such that each of the competing fantasy sports teams never plays a real-life sports game against at least one of the other competing fantasy sports teams.

During the course of a sports season, each fantasy sports team may be matched up against one other fantasy sports team for a given time period, for example one week. During that week, each fantasy sports team may accumulate points based on specific sport statistics accumulated by the fantasy sports players during the actual, real life sport games. The total points for each fantasy sports team are then calculated and totaled, with the team with the highest point total winning that week's match-up. Each fantasy sports team may then play a different fantasy sports team the following week, until the season is over, or at some other predetermined time. The fantasy sports team with the most wins at the end of the season wins the corresponding fantasy sports league (organized group of fantasy sports teams).

Throughout the course of the fantasy sports season, team managers may trade players on their team to other fantasy sports teams by negotiating terms of a player trade (generally including both giving and receiving players). However, these fantasy sports player trades have no bearing on the actual corresponding professional/semi-professional/amateur player or the players actual, real life, sports team. Every transaction in fantasy sports is virtual only, and has no impact or influence on the professional/semi-professional/amateur players or the actual professional/semi-professional/amateur teams.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out herein.

### BRIEF DESCRIPTION OF THE DRAWINGS

The features and advantages of the disclosure will become apparent from a consideration of the subsequent detailed description presented in connection with the accompanying drawings in which:

FIG. 1 is a flow chart illustration of an embodiment of the current disclosure, illustrating the formation of a fantasy football league;

FIG. 2 is a flow chart illustration of another embodiment of the current disclosure, representing player draft order;

FIG. 3 is a schematic illustration of a first embodiment of the current disclosure;

FIG. 4 is a schematic illustration of a second embodiment of the current disclosure;

FIG. 5 is a schematic illustration of a third embodiment of the current disclosure; and

FIG. 6 is an exemplary representation of a further embodiment of the current disclosure representing the standings of fantasy sports teams in a fantasy sports league.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure.

Before the systems and associated methods relating to the disclosed live action, real time, fantasy sports are disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the disclosure will be limited only by the claims and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

The present disclosure is directed to a live action, real-time, fantasy sports league, comprised of fantasy sports teams. Football will be used as an exemplary embodiment of the fantasy sports league in the detailed description below, however, other sports have also been considered as part of the invention, such as, baseball, basketball, hockey, soccer, or any other desired sport.

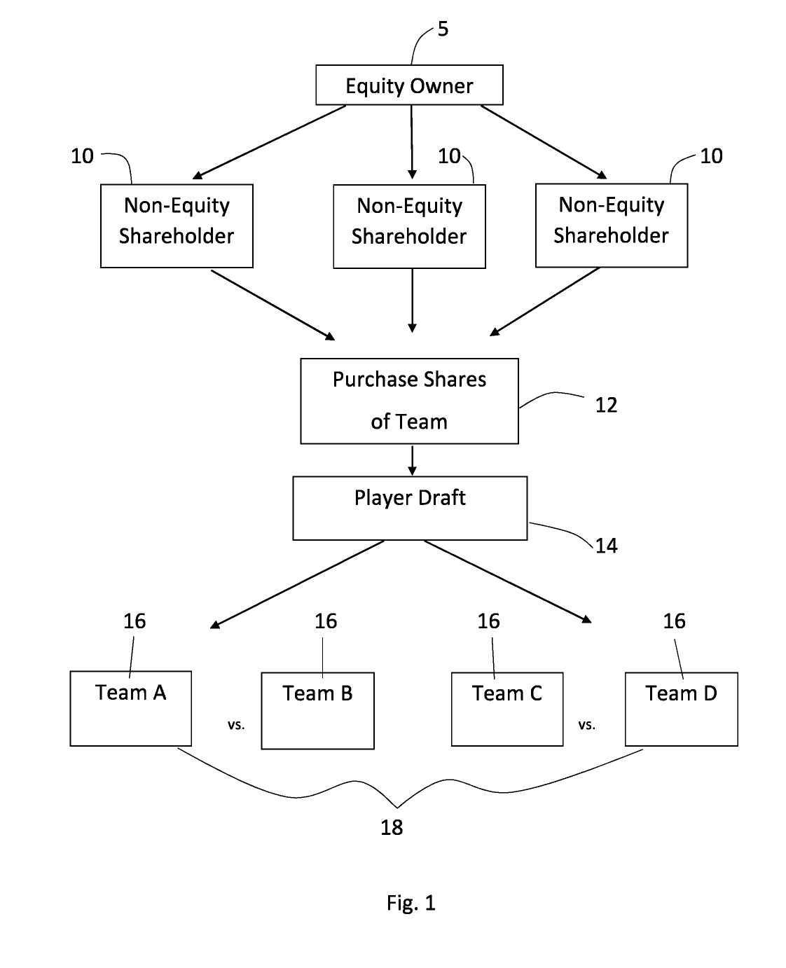

As illustrated in FIG. 1, the formation of a fantasy football league according to the present disclosure may include actual professional or semi-professional football players that are organized on teams owned by at least one equity owner 5 and managed by fantasy football team owners 10. The formation of this fantasy football league may begin with an equity owner 5 or group of equity owners who purchase and own equity in a fantasy football team. The equity owner 5 may be a single individual, group of individuals, or even a business entity, including but not limited to, a corporation, Limited Liability Company, Limited Liability Partnership or other business organization, but could also include, for example, an un-formed partnership or a general partnership. The equity owner 5 then may transfer specific managerial responsibilities of the respective fantasy football team to non-equity shareholders 10. These non-equity shareholders 10, also referred to as “fantasy team shareholders” may be individuals, groups of individuals, or even a single individual, who may pay a designated fee to manage, all or part of, a fantasy football team. These non-equity shareholders 10 may also, if desired, be a non-employee of the corresponding fantasy football team, although in alternative embodiments the non-equity shareholders 10 may be employees of the corresponding fantasy football team or have some equity in the fantasy football team. Each fantasy football team may include fantasy shares of the team (which could be referred to as “shares of team”) which may be purchased 12 or leased by a single individual, group of individuals, or even a business entity, including but not limited to, a corporation, Limited Liability Company, Limited Liability Partnership or other business organization, but could also include, for example, an un-formed partnership or a general partnership. Each person or entity that purchases 12 or leases at least one share of a fantasy football team would be considered a non-equity shareholder of the respective team. In alternative embodiments, fantasy football team shareholder may be given a share of the fantasy football team without payment or a lease requirement. Each of the fantasy football team shareholders 10, may not have actual equity in the fantasy football team but instead be limited to only decision making and managerial roles and responsibilities, such as those further defined below, or in alternative embodiments, the fantasy football team shareholders 10 may receive equity in their respective fantasy football team through the purchase 12 of the at least one share of the fantasy football team. Each fantasy football team, in a given fantasy football league, may have the same number of fantasy shares and each share may have the same purchase price or monetary value. In alternative embodiments, individual fantasy football teams may have a different number fantasy shares from one another, within the same league, and the fantasy shares may also have differing purchase prices and/or monetary values. Fantasy football team shareholder 10 may also be limited to one year or one season terms as shareholder of a fantasy football team, having to re-purchase at least one share of a fantasy football team each new year or season. In other embodiments of the present disclosure, a fantasy football team shareholder 10 may be a shareholder for multiple years before being released of being forced to purchase new shares of a fantasy football team.

In contrast to conventional fantasy football leagues, the fantasy football league of the current disclosure may be self contained, meaning, the league does not rely on players concurrently playing for other professional football leagues or other independent football organizations. Instead, the fantasy football league of the current disclosure is formed with football players specifically designated and employed for the express purpose of facilitating the fantasy football league. In an embodiment of the present disclosure, the fantasy football league is comprised of actual, physical, football teams, made up of actual, physical, football players, that constitute respective fantasy football teams, meaning the physical football team and the respective fantasy football team are one and the same. Accordingly, one example of a fantasy sports team is a fantasy football team as described in this paragraph as an an embodiment of the current disclosure. The very same characteristics and conditions of a fantasy football team as described in this paragraph, could be used to form a fantasy football team as part of a fantasy baseball league or used to form a fantasy basketball team as part of a fantasy basketball league or used to form a fantasy hockey team as part of a fantasy hockey league, used to form a fantasy soccer team as part of a fantasy soccer league or used to form any other desired fantasy sports team as part of a desired fantasy sports league.

In another embodiments, a fantasy football team may include players from a corresponding actual physical team and players who play in other football leagues.

Similar to conventional football leagues, the fantasy football league of the current disclosure, as illustrated in FIG. 1, may hold a player draft 14. However, as shown in FIG. 1, in the disclosed fantasy football league, each of the fantasy team shareholders 10 may select actual football players to play for, and field all required or desired positions on, their corresponding fantasy football team 16. All of the football players drafted 14 for a specific fantasy football team 16 will actually play football together on the same designated fantasy football team 16, managed by the corresponding fantasy football shareholders 10. Competing fantasy football teams 16 (shown in FIG. 1 as Team A, Team B, Team C and Team D) may then play football games 18 against one another. Thus, the entire fantasy football league is formed of actual, real-life, drafted football players 14, playing for real-life (not virtual) football teams 16 formed by fantasy football team shareholders 10.

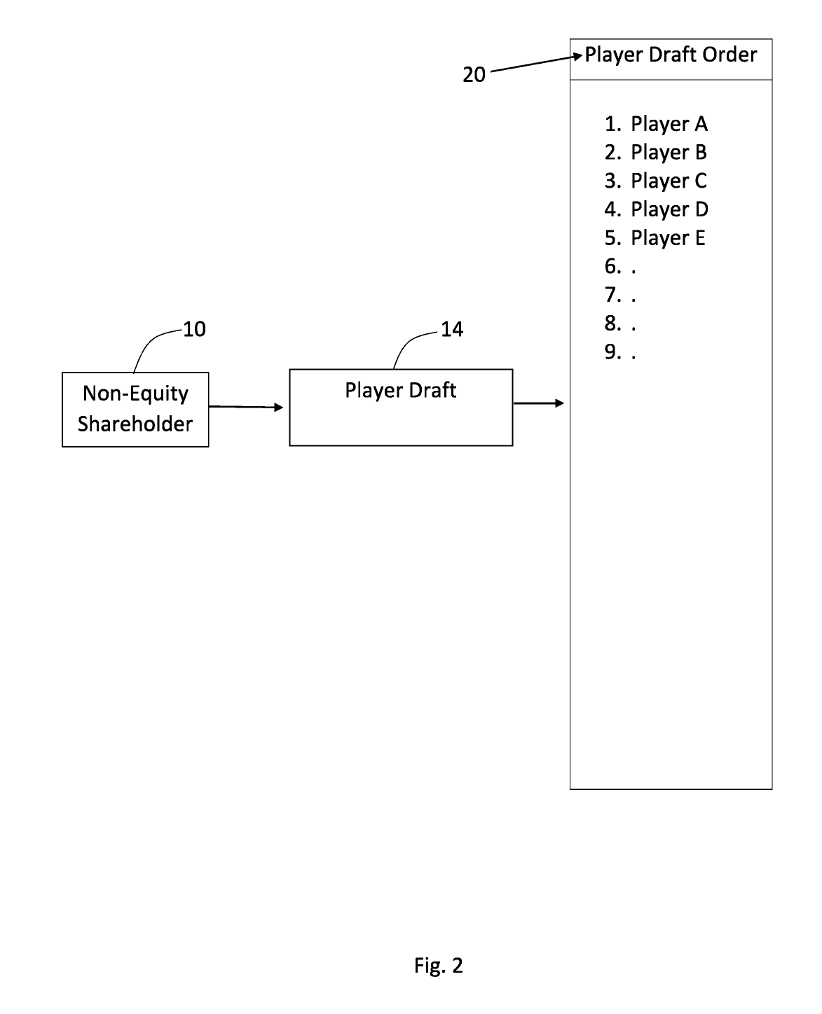

As illustrated in FIG. 2, each new year or football season the fantasy football league may draft or re-draft 14 players for each participating team, so each year the participating fantasy football teams may have different players and possibly a completely different player roster. The salaries or compensation of the corresponding players may be dictated, negotiated and/or adjusted by the corresponding fantasy team shareholders. The salaries or compensation may be determined based on a number of different desired metrics, for example, the statistical performance of the individual players during the entire previous season or even based on the statistical performance of the individual players during individual games. As shown in FIG. 2, the salary of the player may also be based entirely on what order 20 they were drafted. For example, the earlier (top of the player draft order shown in FIG. 2) in the draft a player is drafted 14 the higher their corresponding salary for that year or fantasy football season.

Alternatively, player compensation may be adjusted on a game-by-game basis based entirely on the statistical performance of the individual players during the previously played game. In another embodiment, the players may be compensated based on a combination of the statistical performance of the previous season or the statistical performance of the pervious game. Players may be under contract to play for a corresponding fantasy football team for multiple years or seasons, or each player contract may be extended in only one-year terms, where each player is released at the end of each year or season.

Each fantasy football team may include more players than can play at one time during a football game, thus enabling some designated football players to be “benched” or not play during a particular game, while still enabling the fantasy football team to field the necessary number of players to play the game. During the fantasy football season, before each game, individual fantasy shareholders may vote for which players on their team roster may be eligible to play in each single game, and which players will be “benched” and ineligible to play in that day's game. The rules of the fantasy league may dictate a cap on how many players may be eligible and ineligible to play in each game.

The fantasy football teams may also hold auctions where the shareholders may bid on which individual shareholder may have the ability to make personnel decisions for each game or, alternatively, personnel decisions may be based on a majority vote of all of the fantasy shareholders. A similar process may be used for trading players between fantasy teams during the season. Players on each fantasy football team may be eligible to be traded by their corresponding shareholder or shareholders, during the season. Trades may be negotiated between competing fantasy football team shareholders, possibly with input from respective coaches, and may include giving and receiving players to and from competing teams. All of these player personnel decisions may be determined by shareholder auctions or a majority of shareholder votes, as discussed above.

Additionally, the fantasy football league may force the fantasy football teams to make player trades during the course of the season by requiring a predetermined number of trades in a given fantasy football season. The fantasy football league may also require every player to have a “bye” week, meaning that each player may need to be “benched” for a specific game during the season or for a specific number of games for a season. These player “bye” weeks may then influence fantasy football team shareholders in their personnel decisions throughout a given season.

The actual, real-life players may be coached by a real-life, in-person coach during the football game, as typically done in real-life sports. However, in an embodiment of the current disclosure, fantasy football team shareholders may be given the opportunity to select a specific football play or plays that will be relayed to the actual football players via the in-person coach. These shareholder-selected plays may be selected and then performed by the football players at designated and predetermined times throughout a given football game. Similar to the player personnel decisions discussed above, the shareholder selected plays may be determined by shareholder auctions or a majority of shareholder votes. These shareholder selected plays may include, for example, simply categories of plays, such as a pass play, run play, kicking play or defensive play, or the shareholder selected play could be more specific, such as a specific type of pass play, a specific type of run play or a specific defensive play. Shareholder selected plays may be designated at predetermined times throughout a given game.

Additionally, to promote activity, participation and improved participant experience, the fantasy football league may provide compensation to shareholders who actually cast a vote and/or participate in shareholder votes or auctions. The shareholders may also receive further compensation if, for example, the play that they voted for is selected by the majority vote, and that play results in a score for the respective fantasy football team. Similar compensation could also be received by the shareholder if the selected play they voted for results in a positive gain for the fantasy football team, such as a first down, for example. This compensation may include a monetary benefit or a non-monetary benefit, such as tickets to a real-life game, face-to-face meetings with the coach or players, or other desired non-monetary benefit.

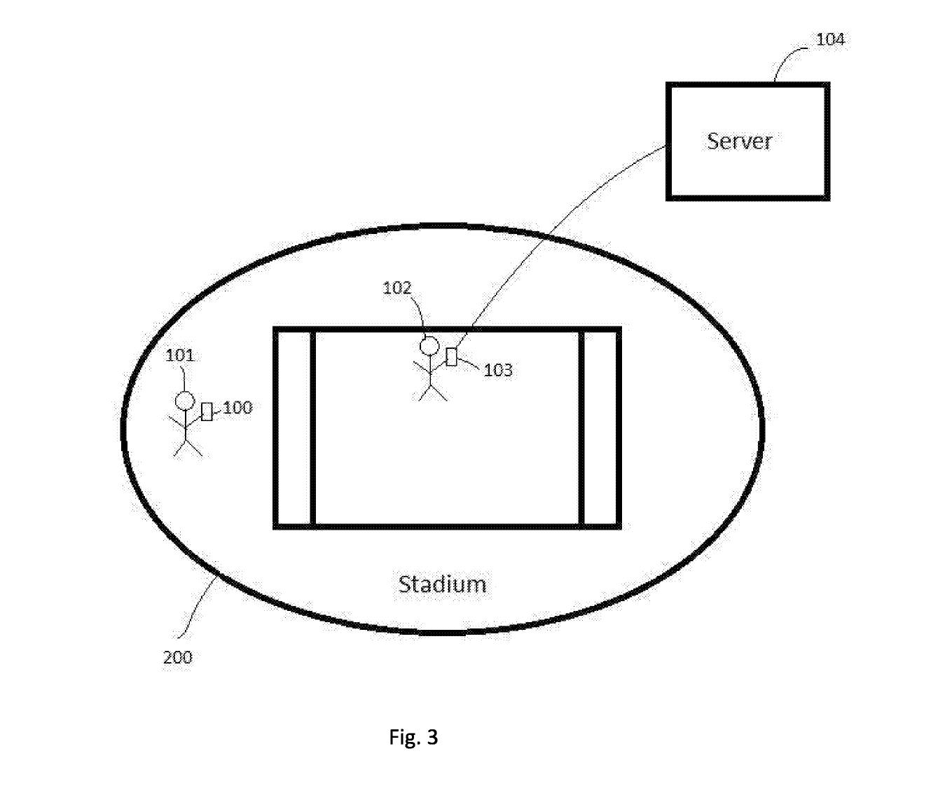

As illustrated in FIG. 3, communication (for example, selecting a play) between the fantasy team shareholder or shareholders 100 and the team coach 102 may be facilitated by an internet connection, text message, or phone call between the coach 102 and the shareholder or shareholders 100. This communication may be facilitated by a server 104, such that the team shareholder 100, may use an electronic device 101 to send a communication to the coach 102 who may receive the communication on an electronic device 103. As shown in FIG. 3, this communication between the team shareholder 100 and the coach 102 may occur while the shareholder is in a stadium 200 watching the football game in-person. Thus, designated shareholder selected plays may be selected by the shareholder 100 and relayed to the team coach 102 in real-time, enabling the shareholder 100 to potentially impact the football game as a pseudo-coach, at least for the shareholder selected plays.

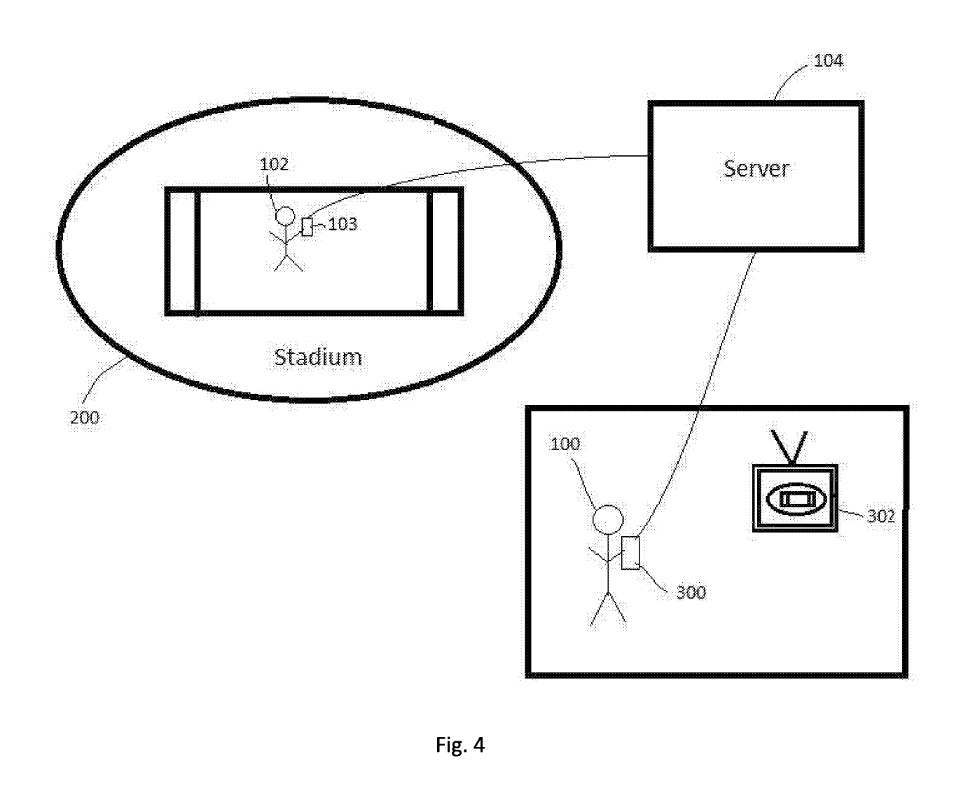

As illustrated in FIG. 4, in another embodiment of the present disclosure, communication between the fantasy team shareholder 100 and the team coach 102 may be facilitated by the server 104, such that the team shareholder 100, may use an electronic device 300 (phone, computer, tablet, etc.) to send a communication to coach 102 who may receive the communication on the electronic device 103 (phone, computer, tablet, etc.). As shown in FIG. 4, this communication between the team shareholder 100 and the coach 102 may occur while the team shareholder 100 is off-site from the stadium 200 watching the football game remotely, for example, on a television 302. Thus, designated shareholder selected plays may be selected by the shareholder 100 and relayed to the team coach 102 in real-time, enabling the shareholder 100 to potentially impact the football game as a pseudo-coach, at least for the shareholder selected plays.

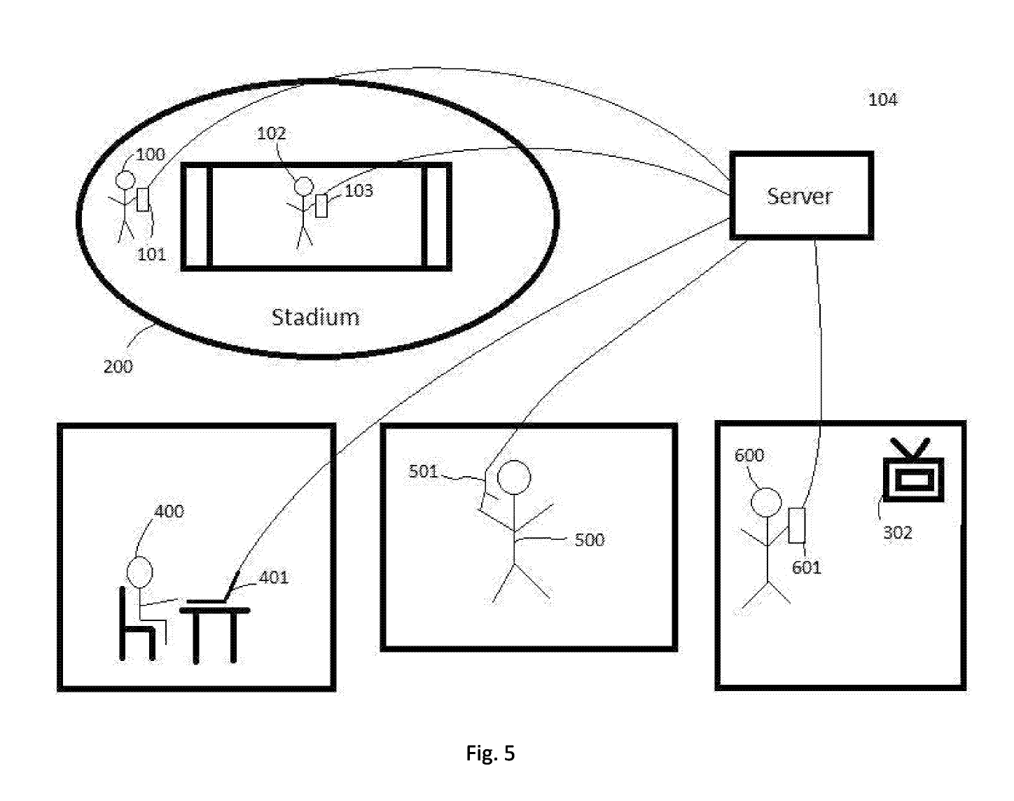

As illustrated in FIG. 5, in another embodiment of the present disclosure, communication may occur between a plurality of fantasy team shareholders 100, 400, 500 and 600, and the team coach 102, simultaneously, or in succession. This communication may be facilitated by the server 104, such that the team shareholders 100, 400, 500 and 600 may use an electronic device 101, 401, 501 and 601 (phone, computer, tablet, etc.), respectively, to send communications to the coach 102 who may receive these communication on the electronic device 103 (phone, computer, tablet, etc.). As shown in FIG. 5, these communications between the team shareholders 100, 400, 500 and 600 and the coach 102 may occur while the team shareholders 100, 400, 500 and 600 are within the stadium 200 in-person or off-site from the stadium 200 watching the football game remotely. Thus, designated shareholder selected plays may be selected by the shareholders 100, 400, 500 and/or 600 and relayed to the team coach 102 in real-time, enabling the shareholder 100 to potentially impact the football game as a pseudo-coach, at least for the shareholder selected plays. The fantasy teams with multiple shareholders may hold shareholder auctions or hold a majority shareholder vote to select the specific plays at the different points in the game.

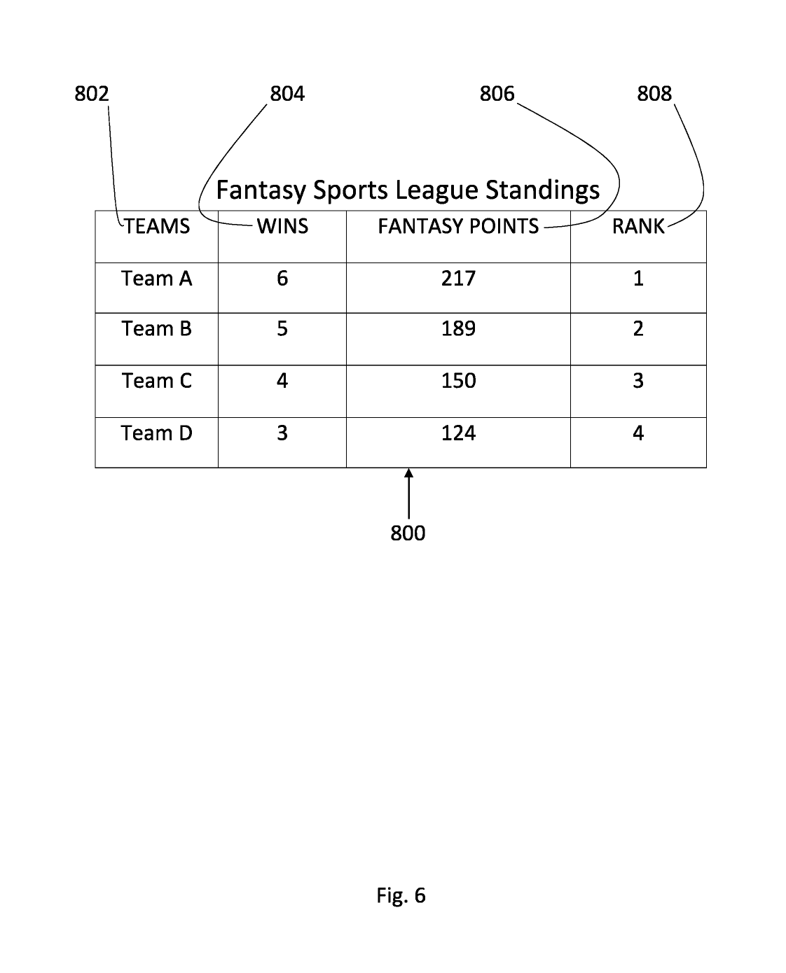

As illustrated FIG. 6, the fantasy football league may calculate a standing 800 or ranking, for each of the respective fantasy football teams 802 in the fantasy football league. Each fantasy football team 802 may accumulate wins 804, based on which the corresponding real-life team wins the actual football game (numerical representations of wins, fantasy points and rank are for exemplary purposes only and do not represent actual calculations or formulations). The actual football games may be played based on traditional professional football rules, or desired variations thereof. In addition, each fantasy football team may accumulate fantasy points 806 based on, for example, player and team statistics during an actual football game (i.e. passing yards, rushing yards, turnovers, etc.). The overall standing or ranking 808 of each fantasy football team within the corresponding fantasy football league may be determined based on a combination of team wins 804 and fantasy points 806.

At the end of each game in the fantasy football league, all of the desired player and team statistics for predetermined categories are entered into a database where the information may be stored. A computer program may then be used to process and convert this statistical information according to a predetermined fantasy point scale. Each player and team statistic may be given a weighted value and the accumulation of the player and team statistics may generate a fantasy point value for the corresponding fantasy football team. Therefore, after each game, the fantasy points for each team are calculated and provided by the computer program. Each fantasy team shareholder may have access to view the fantasy points generated by each fantasy football team after each game that is played.

In traditional football, or other organized sports leagues, overall team standings are determined based on the relative number of wins and loses of each competing team, with the team with the highest number of wins being the first place team, or champion of the league. In an embodiment of the current disclosure, the standings of the fantasy football teams in the fantasy football league may be determined solely based on the number of fantasy points generated by the fantasy football teams. In alternative embodiments of the current disclosure, the standings of the fantasy football teams in the fantasy football league may be determined based on a weighted combination of both the number of wins a team has and the number of fantasy points accumulated by the team.

The fantasy football teams ranked highest in the standings in the corresponding fantasy football league at the end of the year or season may compete in a playoff tournament and championship game, similar or the same as, other professional/semi-profession football leagues. At the end of the fantasy football season the fantasy football team shareholders may recoup or gain a monetary bonus based on their team's performance, with the first place team receiving the biggest bonus or payout. Other bonuses and compensation may be provided to the fantasy football team shareholders based on other categories, as well, such as, which fantasy football team scored the most actual points in a given game, or accumulated the most fantasy points for a given game. These bonuses and monetary payouts may be paid from revenue generated by the fantasy football league via, for example, ticket sales for the actual football games, concessions at the stadium or arena where the games are played, sponsorships, broadcasting contracts, etc.

In another embodiment of the current disclosure, a group of potential fantasy team shareholders may organize and participate in a sub-fantasy football league, as a subset of the overall fantasy football league. In the creation of the sub-fantasy football league, a group of potential fantasy team owners may establish the sub-fantasy football league with a predetermined number of potential fantasy team shareholders. These potential fantasy team shareholders may then jointly, or select an representative potential fantasy team shareholder to, select a name for the sub-fantasy football league. The potential fantasy team shareholders may each purchase shares of respective fantasy football teams, with the shares corresponding to the shares purchased 12 by fantasy team shareholders 10, illustrated in FIG. 1. However, the potential fantasy team shareholders may receive a discount purchase price on the team shares based on the number of number of potential fantasy team owners in the sub-fantasy football league, resulting in essentially a group discount.

Once the potential fantasy team owners pay their discounted fee for purchasing their corresponding fantasy football team shares, they then become fantasy football team shareholders, equivalent to the non-equity fantasy football team shareholders 10 discussed above and illustrated in FIG. 1, and each of the shareholders may be assigned, at random, to a fantasy football team 16 in the fantasy football league. In another exemplary embodiment, a shareholder of the sub-fantasy football league may be able to request to be on a desired fantasy football team 16 in the fantasy football league. Like other non-equity fantasy football shareholders 10 discussed above, the shareholders of the sub-fantasy football league may be able to participate in and manage their respective fantasy football team 16, by participating in, for example, the player draft 14, communicating with the team coach, calling plays in real-time, and trading players.

The share price paid by the fantasy football team shareholders of the sub-fantasy football league may be designated and held in a specific account reserved for earnings, bonuses and/or payouts made to the season winning fantasy team shareholder of the sub-fantasy football team. These earnings, bonuses and/or payouts may be determined using the same methodology discussed above with respect to the fantasy football league. In an alternative embodiment, each shareholder in the sub-fantasy football league may also form a fantasy only team using players playing in the fantasy football league. Each of the sub-fantasy football league shareholders may select players for their corresponding fantasy only football team. This player selection process may mimic the player draft 14 discussed above, however, the players drafted for the fantasy only football teams will be virtual only. These fantasy only football teams will not have corresponding real-life football team, as with the fantasy football teams 16 discussed above. Accordingly, the fantasy only football teams will only accumulate fantasy points based on, for example, player and team statistics during an actual football game (i.e. passing yards, rushing yards, turnovers, etc.), as discussed with respect to the fantasy points 806. The shareholders may also trade players from their respective fantasy only football team to any other fantasy only football team in the sub-fantasy football league by negotiating with the corresponding shareholders of such fantasy only football teams.

The sub-fantasy football league may then calculate a standing or ranking of each fantasy football team shareholder in the sub-fantasy football league. For example, each fantasy football team shareholder in the sub-fantasy football league may accumulate fantasy points based on their corresponding fantasy football team 16, which will accumulate team wins 804 and fantasy points 806, as discussed above. Each fantasy football team shareholder of the sub-fantasy football team may also accumulate fantasy points 806 based on their corresponding fantasy only football team. An overall point value may then be calculated by weighing the team wins 804 and fantasy points 806 of the shareholder's respective fantasy football team 16 and the shareholder's respective fantasy only football team. The standing or ranking of the sub-fantasy football league may then be based on the overall point total accumulated by each respective shareholder in the sub-fantasy football league.

As similarly discussed above, at the end of the fantasy football season the fantasy football team shareholders of the sub-fantasy football league may recoup or gain a monetary bonus based on their corresponding teams' performances, with the first place shareholder receiving the biggest bonus or payout. Other bonuses and compensation may be provided to the fantasy football team shareholders based on other categories, as well, such as, which fantasy football team scored the most actual points in a given game, or accumulated the most fantasy points for a given game. These bonuses and monetary payouts may be paid from the designated account of paid shares. In other exemplary embodiments, the fantasy football team shareholders may also earn bonuses and compensation based on their respective fantasy football team 16 performance in the fantasy football league, as discussed above.

In a further embodiment, a fantasy football league may include at least one fantasy football managed by at least one fantasy football team shareholder. The fantasy football team shareholder or shareholders may be determined as described with any of the embodiments disclosed herein and each of the shareholders may receive any or all of the benefits and responsibilities of any of the other shareholders disclosed herein in other embodiments.

In this embodiment the fantasy football team may play a real-life football game against another real-life football team, however, the other real-life football team may not be a “fantasy football team” as described above, such that the other real-life football team may not be managed by a fantasy football shareholder. The fantasy football team may accrue fantasy points based on the real-life football game. These fantasy points may be separate and distinct from the football points accumulated in the real-life football game. These fantasy points may be calculated in the same manner as the fantasy points disclosed in the other embodiments above.

In the foregoing Detailed Description of the Disclosure, various features of the disclosure are grouped together in a single embodiment for the purpose of streamlining the disclosure. This method of disclosure is not to be interpreted as reflecting an intention that the disclosure requires more features than are expressly recited in each claim of the non-provisional application. Rather, inventive aspects lie in less than all features of a single foregoing disclosed embodiment.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

1. A fantasy sports league comprising:
a plurality of competing fantasy sports teams, wherein each team is managed by at least one fantasy team shareholder and includes a plurality of players;
wherein the at least one fantasy team shareholder selects each player to be on the fantasy sports team; and
wherein each of the competing fantasy sports teams plays a real-life sports game against at least one of the other competing fantasy sports teams.

2. The fantasy sports league of claim 1, wherein the competing fantasy sports teams will play games for a season and the season will end after a predetermined number of games; and
all the players from each of the competing fantasy sports teams are released from their fantasy sports teams at the end of the season.

3. The fantasy sports league of claim 2, wherein a draft is conducted after the end of the season, where each of the fantasy team shareholders select players for their corresponding fantasy sports team.

4. The fantasy sports league of claim 3, wherein each of the players are paid a salary for playing on their respective fantasy sports team, and the salary of each player is determined based on which position they were drafted with respect to the other players selected in the draft.

5. The fantasy sports league of claim 1, wherein each fantasy sports team includes a predetermined number of fantasy shares and each fantasy team shareholder purchases at least one fantasy share of their respective fantasy sports team.

6. The fantasy sports league of claim 5, wherein each fantasy sports team includes a plurality of fantasy team shareholders.

7. The fantasy sports league of claim 1, wherein each fantasy sports team is coached by an in-person coach during the games, wherein the coach calls plays for the players to run during the games.

8. The fantasy sports league of claim 6, wherein at least one of the fantasy team shareholders selects at least one of the plays that the players will run during the game and communicate that selection to the coach during the game.

9. The fantasy sports league of claim 8, wherein the at least one fantasy team shareholder selecting the at least one play, includes a fantasy team shareholder who won an auction for an opportunity to select at least one of the plays that the players will run during the game.

10. The fantasy sports league of claim 8, wherein the at least one fantasy team shareholder selecting the at least one play, includes a plurality of fantasy team shareholders, wherein the selection of the play is determined by a majority vote of the plurality of fantasy team shareholders.

11. The fantasy sports league of claim 10, wherein each of the plurality of fantasy team shareholders who cast a vote for the selection of the play will receive compensation.

12. The fantasy sports league of claim 10, wherein the compensation is monetary.

13. The fantasy sports league of claim 11, wherein each of the plurality of fantasy team shareholders who cast a vote for the selection of the play, and the play results in a score by the fantasy sports team, will receive compensation.

14. The fantasy sports league of claim 10, wherein the compensation is monetary.

15. The fantasy sports league of claim 1, wherein the fantasy sports league and the fantasy sports teams play the games based on the rules of one of, football, baseball, hockey and soccer.

16. The fantasy sports league of claim 1, further comprising:
a team standings, ranking the relative performance of each of the fantasy sports teams, wherein the standings are based on fantasy points accumulated by each respective fantasy sports team.

17. The fantasy sports league of claim 16, wherein the fantasy points are calculated based on weighted values based on in-game performance of the players and fantasy sports teams.

18. The fantasy sports league of claim 17, wherein the in-game performance of the players and the teams include, player and team performance statistics accrued during the game.

19. The fantasy sports league of claim 1, wherein the at least one fantasy team shareholder trades at least one player from the fantasy team shareholder's team to another fantasy sports team.

20. The fantasy sports league of claim 1,
further comprising:
a sub-fantasy sports league having:
a plurality of fantasy only sports teams, wherein each of a predetermined number of the fantasy team shareholders of the plurality of competing fantasy sports teams also manage one of the fantasy only sports teams.

21. The fantasy sports league of claim 20, wherein each of the fantasy only sports teams includes virtual players represented by the players on the fantasy sports teams.

22. The fantasy sports league of claim 21, wherein the fantasy only sports team and fantasy sports team managed by the same fantasy sports shareholder do not include the same players.

23. The fantasy sports league of claim 20, further comprising:
a fantasy team shareholder standings of the sub-fantasy football league, wherein the standings are based on fantasy points accumulated by a combination of each respective fantasy sports team and corresponding fantasy only sports team.

24. The fantasy sports league of claim 23, wherein the fantasy points are calculated based on weighted values accumulated by the fantasy sports team and fantasy only sports team managed by the same fantasy team shareholder.

25-47. (canceled)

48. A fantasy sports league comprising:
a plurality of competing fantasy sports teams, wherein each team is managed by at least one fantasy team shareholder and includes a plurality of players, wherein each fantasy sports team includes a predetermined number of fantasy shares and each fantasy team shareholder purchases at least one fantasy share of their respective fantasy sports team;
wherein the at least one fantasy team shareholder selects each player to be on the fantasy sports team;
wherein each of the competing fantasy sports teams plays a real-life sports game against at least one of the other competing fantasy sports teams and the competing fantasy sports teams will play games for a season and the season will end after a predetermined number of games;
wherein all the players from each of the competing fantasy sports teams are released from their fantasy sports teams at the end of the season and a draft is conducted after the end of the season, wherein each of the fantasy team shareholders select players for their corresponding fantasy sports team and each of the players are paid a salary for playing on their respective fantasy sports team, wherein the salary of each player is determined based on which position they were drafted with respect to the other players selected in the draft;
wherein each fantasy sports team is coached by an in-person coach during the games, and the coach calls plays for the players to run during the games;
wherein at least one of the fantasy team shareholders selects at least one of the plays that the players will run during the game and communicate that selection to the coach during the game; and
a team standings, ranking the relative performance of each of the fantasy sports teams, wherein the standings are based on fantasy points accumulated by each respective fantasy sports team, wherein the fantasy points are calculated based on weighted values based on in-game performance of the players and fantasy sports teams.

49. A fantasy sports league comprising:
a plurality of competing fantasy sports teams, having at least a first fantasy sports team and a second fantasy sports team, wherein the first fantasy sports team is managed by at least a first fantasy team shareholder and the second fantasy sports team is managed by at least a second fantasy team shareholder;
wherein the first fantasy team shareholder owns no equity in the first fantasy sports team and the second fantasy team shareholder owns no equity in the second fantasy sports team;
wherein the first fantasy team shareholder is not an employee of the first fantasy sports team and the second fantasy team shareholder is not an employee of the second fantasy sports team; and
wherein the first fantasy sports team and the second fantasy sports team play a real-life sports game against one another.

50. The fantasy sports league of claim 49, wherein each of the first and second fantasy sports teams includes a coach, wherein the coach on the first fantasy sports team is chosen by the first fantasy team shareholder, and the coach of the second fantasy sports team is chosen by the second fantasy team shareholder.

51. The fantasy sports league of claim 50, wherein each of the first and second fantasy sports teams includes a plurality of players, wherein at least one of the players on the first fantasy sports team is chosen by the first fantasy team shareholder, and at least one of the players on the second fantasy sports team is chosen by the second fantasy team shareholder.

52. The fantasy sports league of claim 50, wherein the first fantasy sports team is managed by a plurality of fantasy team shareholders, wherein a managerial decision made by the plurality of fantasy team shareholders is determined by based on a majority vote of the fantasy team shareholders.

53. A fantasy sports team comprising:
a plurality of players;
at least one fantasy team shareholder who manages the fantasy sports team;
wherein the fantasy team shareholder owns no equity in the fantasy sports team;
wherein the fantasy team shareholder is not an employee of the fantasy sports team;
wherein the fantasy sports team plays a real-life sports game against another sports team;
wherein the fantasy sports team will accrue fantasy points based on the real-life sports game, and the fantasy points are calculated based on weighted values based on in-game performance of the players and fantasy sports team, during the real-life sports game.

54. The fantasy sports team of claim 53, wherein the fantasy sports team includes a coach, wherein the coach is chosen by the at least one fantasy team shareholder.

55. The fantasy sports team of claim 54, wherein at least one of the players on the fantasy sports team is chosen by the at least one fantasy team shareholder.

56. The fantasy sports team of claim 53, wherein the fantasy sports team is managed by a plurality of fantasy team shareholders, wherein a managerial decision made by the plurality of fantasy team shareholders is determined by based on a majority vote of the plurality of fantasy team shareholders.
